(19) United States
(12) Patent Application Publication
(10) Pub. No.: US 2010/0086120 A1
(43) Pub. Date: Apr. 8, 2010

(54) SYSTEMS AND METHODS FOR CALL CENTER ROUTING

(75) Inventors: Aaron David Brussat, Tucker, GA (US); John James DeMonica, Atlanta, GA (US)

Correspondence Address: PHILIP H. BURRUS, IV, 460 Grant Street, Atlanta, GA, 30312, US

(73) Assignee: CompuCredit Intellectual Property Holdings Corp. II, Las Vegas, NV (US)

(21) Appl. No.: 12/244,398

(22) Filed: Oct. 2, 2008

(51) Int. Cl. H04M 5/00

(52) U.S. Cl. 379/265.12

(57) ABSTRACT

Systems and methods for routing calls received by a call center are provided. One or more performance metrics for ranking call center agents may be determined, and a plurality of call center agents may be ranked based at least in part on the one or more performance metrics. A call may be received and a determination may be made of one of the plurality of call center agents to route the received call to. The determination may be based at least in part on the rankings and respective utilization of the plurality of call center agents. The received call may be routed to the one of the plurality of call center agents.

### FIELD OF THE INVENTION

This invention relates generally to call center routing, and more specifically, to call center routing based on one or more performance metrics.

### BACKGROUND OF THE INVENTION

Call centers are utilized by a wide variety of businesses and other entities to process a wide variety of received calls, such as, customer service calls, technical support calls, purchase order calls, account access calls, etc. Conventional call centers receive a plurality of customer calls and route those call to a plurality of customer service agents.

Conventional call centers that handle customer service or technical support calls typically segregate received calls by product or service using an interactive input server and an automatic call distributor. Once segregated, calls are typically processed and distributed to customer service agents on a first come first serve basis. Calls are typically distributed to the first agent that becomes available or to the agent that has been idle the longest.

The routing utilized by conventional call centers, however, may result in calls being assigned to relatively lower performing agents if those agents are available. Being assigned to a lower performing agent may lead to a longer average handle time for a call and/or to greater customer dissatisfaction.

Accordingly, there is a need for systems and methods for call center routing. Additionally, there is a need for systems and methods for call center routing based on one or more performance metrics.

### BRIEF SUMMARY OF THE INVENTION

Some or all of the above needs and/or problems may be addressed by embodiments of the invention. Embodiments of the invention may include a computer-implemented method for routing calls received at a call center. One or more performance metrics for routing calls may be determined and a plurality of call center agents may be ranked based at least in part on the one or more performance metrics. A call may be received and a determination may be made, based at least in part on the rankings and respective utilizations of the plurality of call center agents, of one or the plurality of call center agents to route the received call to. The received call may then be routed to the one of the plurality of call center agents.

Another embodiment of the invention may provide a system for routing calls received at a call center. The system may include at least one inbound call queue, at least one memory, and at least one processor. The at least one inbound call queue may be operable to receive a call. The at least one memory may be operable to store performance metrics for ranking call center agents. The at least one processor may be operable to access the at least one memory to obtain one or more performance metrics and to rank a plurality of call center agents based at least in part on the one or more performance metrics. The at least one processor may further be operable to determine, based at least in part on the rankings, one of the plurality of call center agents to route the received call to, and to control the routing of the call from the at least one inbound call queue to the one of the plurality of call center agents.

Another embodiment of the invention may include a computer-implemented method for routing calls at a call center. One or more performance metrics for ranking call center agents may be determined. Respective proficiency scores for a plurality of call center agents may be determined based at least in part on the one or more performance metrics and on respective historical data associated with the plurality of call center agents. The plurality of call center agents may be ranked based at least in part on the determined proficiency scores, and one of the plurality of call center agents may be selected as an agent to which a call is to be routed based at least in part on the rankings.

Additional systems, methods, features, and advantages are realized through the techniques of various embodiments of the invention. Other embodiments and aspects are described in detail herein and are considered a part of the claimed invention. Other advantages and features can be understood with reference to the description and to the drawings.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of one example call routing system in accordance with an illustrative embodiment of the invention.

FIG. 2 is a flowchart depicting one example method for processing a call received by a call routing system, according to an illustrative embodiment of the invention.

FIG. 3 is a flowchart depicting one example method for routing a call based at least in part on one or more performance metrics, according to an illustrative embodiment of the invention.

FIG. 4 is a flowchart depicting one example method for ranking call center agents, according to an illustrative embodiment of the invention.

FIG. 5 is a flowchart depicting one example method for processing a call received by a call routing center, according to an illustrative embodiment of the invention.

FIG. 6 is a chart illustrating one example of modifying agent scores over time in a call routing system, according to an illustrative embodiment of the invention.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Disclosed are systems and methods for routing calls received at a call center. A plurality of agents at the call center may be individually ranked based at least in part on one or more performance metrics or performance parameters. When a call is received by the call center, the received call may be routed to an agent based at least in part on the ranking of the agent with respect to the other agents and based at least in part on the utilization of the agent. In this regard, calls may be routed to higher performing agents, leading to relatively higher customer satisfaction and/or other improvements in call center metrics.

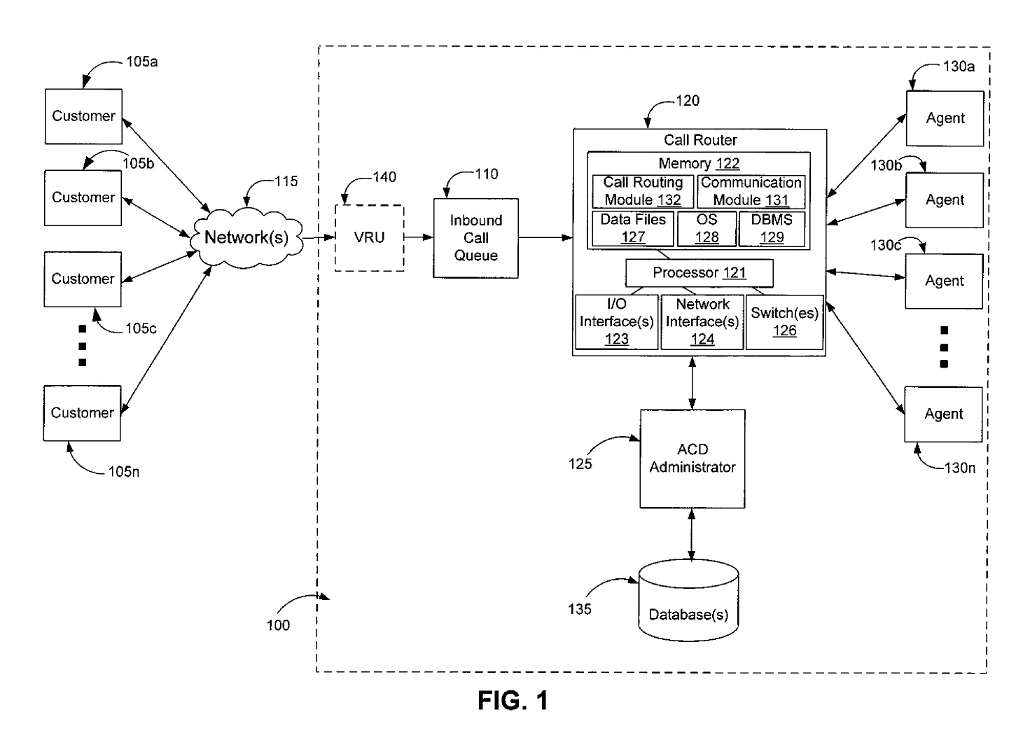

FIG. 1 is a block diagram of one example call routing system 100 in accordance with an illustrative embodiment of the invention. The call routing system 100 may include, among other components, an inbound call queue 110, a call router 120, an automatic call distributor (“ACD”) administrator 125, and a plurality of call center agents 130a-n. The call routing system 100 may receive one or more calls from one or more customers 105a-n via at least one network 115. The call routing system 100 may determine an appropriate call center agent, such as agents 130a-n, to route the call to. The determination of an appropriate agent may be based at least in part on one or more performance metrics or performance parameters and a ranking of the agents 130a-n in accordance with the one or more performance metrics.

One or more customers 105a-n or callers may dial or call into the call routing system 100 for a wide variety of different purposes. For example, the one or more customers 105a-n may dial into the call routing system for a customer service call, a technical support call, a purchase order call, an account access call, or for any other call as desired in various embodiments of the invention. For purposes of this disclosure, an individual customer or caller will be referred to as customer 105a.

Additionally, a customer 105a may utilize any suitable device or devices to call into the call routing system 100, for example, a telephone, a cellular phone, a voice over Internet protocol (“VoIP”) phone, etc. One or more suitable networks 115 may facilitate communication between a suitable customer device and the call routing system 100.

The one or more networks 115 may include one or more suitable networks for receiving calls. A wide variety of different types of networks may be utilized as desired in various embodiments of the invention, for example, a public switch telephone network (“PSTN”), a cellular telephone network, the Internet, a private intranet, etc.

Calls may be received by the call routing system 100 and stored in the inbound call queue 110 until they are routed to an appropriate call center agent 130a-n by the call router 120. The inbound call queue 110 may place a call on hold until the call is routed to an agent 130a. According to one embodiment, the inbound call queue 110 may be a first in, first out (“FIFO”) queue. Additionally, in some embodiments, more than one inbound call queue 110 may be provided. In this regard, incoming calls may be separated or sorted in accordance with a wide variety of different criteria, for example, the subject matter of the call, the importance of the customer, etc. As an example, a technical support call may be held in a first inbound call queue and an account inquiry call may be held in a second inbound call queue.

In some embodiments of the invention, a voice response unit (“VRU”) 140 may be utilized to receive information from a customer 105a prior to a call being stored in an appropriate inbound call queue 110. The VRU 140 may be an automated system that presents one or more voice prompts to a customer 105a to solicit desired information from the customer. The VRU 140 may receive information from the customer 105a via any suitable methods, devices, techniques or other means, for example, via touchtone key input by the customer 105a or via voice recognition of instructions or data received from the customer. A wide variety of different information may be solicited and/or received by the VRU 140 as desired in various embodiments of the invention, for example, a customer name, a customer account number, product information, a type of problem, etc. At least a portion of the received information may then be utilized in association with the call routing. For example, at least a portion of the received information may be utilized to select an inbound call queue that the call will be stored in. As another example, at least a portion of the received information may be utilized in a determination of an appropriate call center agent 130a-n to whom the call will be routed, as discussed in greater detail below.

The call router 120 may determine an appropriate agent 130a-n to which a call stored in an inbound call queue 110 should be routed. Following the determination, the call router 120 may route the call to the appropriate agent, such as agent 130a. For purposes of the present disclosure, it will be assumed that the determined agent to which an example incoming call is to be routed is agent 130a. For purposes of this disclosure, the agent 130a may also be referred to as the agent 130.

The call router 120 may be any processor-driven device or plurality of devices, such as a personal computer, laptop computer, handheld computer, server and the like, that is configured to determine an appropriate call center agent 130a to which an incoming call is to be routed. The call router 120 may include a processor 121, a memory 122, input/output (“I/O”) interface(s) 123, a network interface 124, and one or more switches 126. The memory 122 may store data files 127 and various program modules, such as an operating system (“OS”) 128, a database management system (“DBMS”) 129, a communications module 131, and a call routing module 132. The communications module 131 may receive data from other components of the call routing system 100, such as, from the ACD Administrator 125. As an example, the communications module 131 may receive various performance metrics, performance parameters, utilization parameters, call routing rules, and/or call routing preferences from the ACD Administrator 125. This received information may be utilized by the call routing module 132 to determine an appropriate call center agent 130a to which an incoming call is to be routed. The one or more switches 126 may then be utilized to facilitate a transfer of the call from an inbound call queue 110 to the appropriate call center agent 130a.

The I/O interfaces 123 may facilitate communication between the call router 120 and one or more input/output devices, for example, a display, keyboard, mouse, control panel, touch screen display, microphone, etc. that facilitate user interaction with the call router 120. The one or more network interfaces 124 may facilitate connection of the call router 120 to one or more suitable networks, for example, a local area network, a wide area network, the Internet a telephone network, etc. Additionally, other components may be included in the call router 120 as desired in various embodiments of the invention.

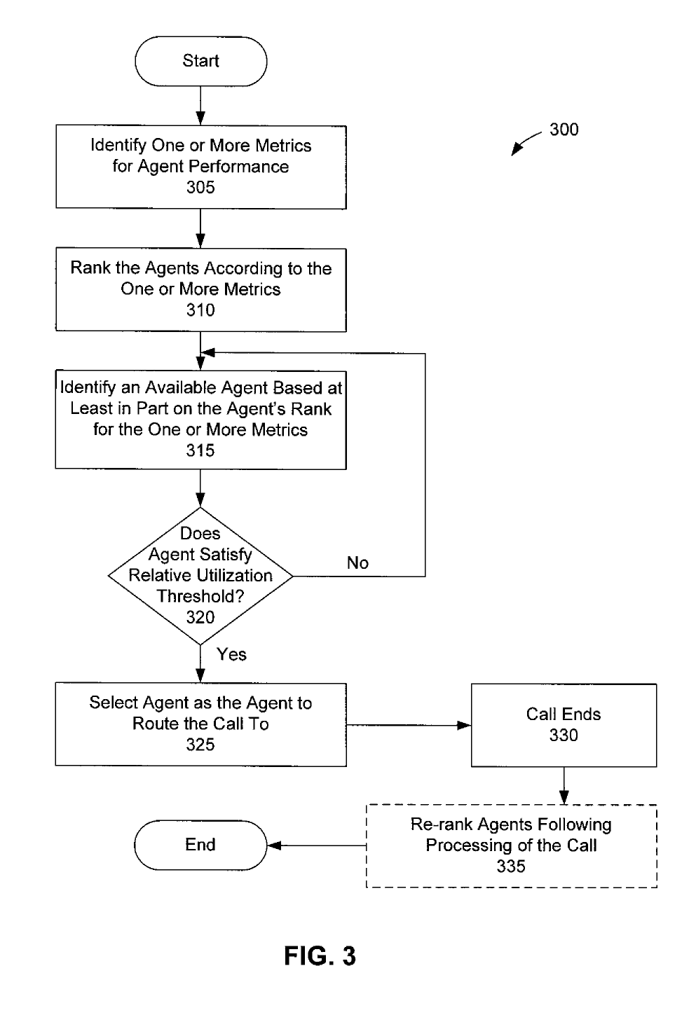

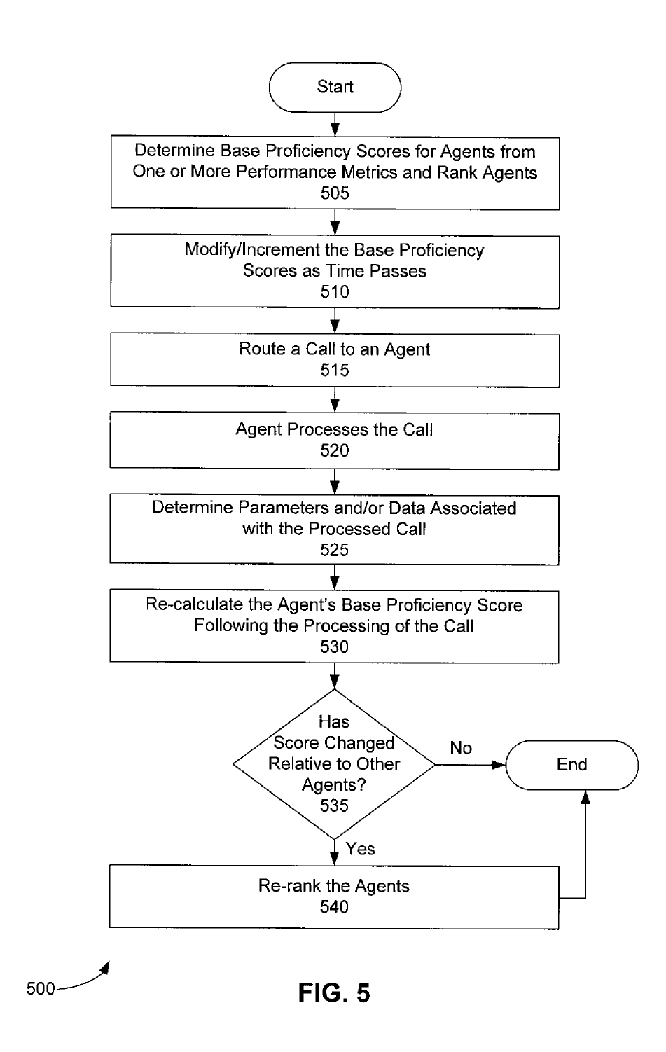

The call routing module 132 may determine an appropriate call center agent 130a based at least in part on a wide variety of different factors, criteria, and/or parameters. According to various embodiments of the invention, the call routing module 132 may rank the call center agents 130a-n in accordance with one or more performance metrics or performance criteria. The call center agents 130a-n may be individually ranked in accordance with the one or more performance metrics. Additionally or alternatively, the call center agents 130a-n may be ranked by the one or more metrics into various groups of agents, for example, relatively high performing agents, relatively standard performing agents, and/or relatively low performing agents. Once the agents 130a-n have been ranked, an agent 130a may be selected by the call routing module 132 based at least in part on the rankings. Additionally, in some embodiments of the invention, the selection of an agent 130a may additionally be based at least in part on the agent's utilization, as explained in greater detail below with reference to FIGS. 3 and 5.

The ACD administrator 125 may determine and/or define a wide variety of different parameters and/or metrics for ranking call center agents 130a-n and/or for utilizing the call center agents 130a-n. Although the ACD administrator 125 is illustrated in FIG. 1 as a separate component from the call router 120, in certain embodiments of the invention, the ACD administrator 125 may be combined with the call router 120 into a single component of the call routing system 100. Additionally, in various embodiments of the invention, the ACD administrator 125 may include components that are similar to those of the call router 120. For example, the ACD administrator 125 may include one or more suitable processor-driven devices that facilitate the functionality of the ACD administrator 125.

According to certain embodiments of the invention, the ACD administrator may define one or more parameters that may be utilized to select a call center agent 130a for call routing. The one or more parameters may include a wide variety of different performance and/or proficiency criteria as desired in various embodiments of the invention. Additionally, the one or more parameters may include a wide variety of different utilization criteria and/or availability thresholds as desired in various embodiments of the invention.

According to an aspect of the invention, call center agents may be ranked in accordance with one or more performance metrics. Additionally, if multiple performance metrics are utilized, the performance metrics may be weighted in certain embodiments of the invention. These performance metrics may include default performance metrics, call center defined performance metrics, call center client defined performance metrics, and/or customer or caller defined performance metrics. One or more default performance metrics may be utilized for agent ranking unless other performance metrics are selected by a user of the call routing system 100. Additionally, in some embodiments of the invention, a plurality of default performance metrics and/or sets of default performance metrics may be provided and a user may select from among the available default performance metrics.

Call center defined performance metrics may include one or more performance metrics that are defined and/or selected by a call center that is utilizing the call routing system 100. Call center client defined performance metrics may include one or more performance metrics that are defined and/or selected by a client of the call center. For example, a client of the call center may be an entity that markets and sells consumer products for which the call center processes technical support calls. As another example, a client of the call center may be a utility company or financial institution for which the call center processes customer service calls. Customer or caller defined performance metrics may include one or more performance metrics that are defined and/or selected by a customer, such as customer 105a, whose call is processed by the call center.

The one or more performance metrics that are utilized may be defined in accordance with a wide variety of different methods or techniques as desired in various embodiments of the invention. For example, default performance metrics may be utilized unless user input is received from one or more entities that define the performance metrics that may be utilized. Additionally, one or more weightings for the one or more performance metrics may be defined in accordance with a wide variety of different methods or techniques. User input may be received in accordance with a wide variety of different methods or techniques. For example, user input for performance metrics may be manually input into the call routing system 100 via one or more suitable I/O devices, and the input for the performance metrics may be stored in one or more suitable memory devices, such as, in database 135. As another example, user input may be electronically received by the call routing system 100 via one or more suitable networks, such as, the Internet or a telephone network or via one or more suitable data transfer devices, such as, CD-ROMS, floppy disks, zip drives, flash memories, thumb drives, or other portable data storage devices. The user input may then be stored in one or more suitable memory devices associated with the ACD administrator 125, such as, in database 135. Additionally, user input may be utilized in certain embodiments to select from available default performance metrics.

A wide variety of different performance metrics may be utilized as desired in various embodiments of the invention. These metrics may relate to an agent's or a group of agents' proficiency at handling or processing received calls. For example, performance metrics may include a score that rates an agent's technical expertise in a given area and/or with a given product. As another example, performance metrics may relate to the time that it takes for an agent or group of agents to process received calls. As yet another example, performance metrics may relate to a customer's satisfaction with a given agent or a given group of agents. Examples of performance metrics that may be utilized include, but are not limited to, average handle time for calls, average hold time for calls, average wrap-up or after work time following calls, agent call quality scores, transfer rate, average transfer rate, average transfer time, first call resolution rate, average first call resolution rate, average non-interaction time, complaint rate, call quality, customer satisfaction, call type, call reason, agent personality, customer personality, other metrics and/or values attributable to a customer, other metrics and/or values attributable to an agent, etc.

The call center agents 130a-n may be ranked in accordance with one or more of the performance metrics. Any number of call center agents 130a-n may be ranked as desired in various embodiments of the invention. Additionally, any number of performance metrics may be utilized in the rankings. In embodiments that utilize more than one performance metric to rank the agents 130a-n, a wide variety of different weightings may be applied to the performance metrics that are utilized. In one example embodiment, the performance metrics that are utilized may be weighted equally. In another example embodiment, the utilized performance metrics may receive different weightings. In this regard, relatively greater weight and/or importance may be attributed to certain of the performance metrics relative to other performance metrics. As with the performance metrics that are utilized, the weightings that are applied to the performance metrics may be determined in accordance with a variety of different inputs and/or methods. For example, default weightings, call center defined weightings, call center client defined weightings, and/or customer or caller defined weightings may be utilized as desired in various embodiments of the invention.

Additionally, the agents 130a-n may be ranked in any suitable manner as desired in various embodiments of the invention. In one embodiment, the agents 130a-n may be individually ranked in accordance with the one or more performance metrics that are utilized. A proficiency score may be determined for each agent based at least in part on the utilized performance metrics and the performance history of the agent. The agents 130a-n may then be ranked in accordance with the determined proficiency scores. As an example, a point value scale may be assigned to a performance metric and the proficiency scores may be determined for the performance metric based on where a particular agent's 130a performance falls on the scale. In other embodiments, various groups of agents may be ranked in accordance with the one or more performance metrics that are utilized. In yet other embodiments, various groups of agents may be ranked in accordance with the utilized performance metrics, and the individual agents within each group may be ranked relative to one another. In some embodiments, the one or more performance metrics utilized to rank the agents within each group may be the same as those utilized to rank the groups; however, in other embodiments, different performance metrics may be utilized as desired. Other methods for determining proficiency scores and/or for ranking agents may be utilized as desired in various embodiments of the invention.

According to certain embodiments of the invention, the performance metrics may be stored in one or more suitable memory devices, such as, in database 135. Additionally, historical information and/or data associated with each of the agents or with groups of the agents may be stored in one or more suitable memory devices, such as, in database 135. A wide variety of different historical information for the agents or groups of agents may be stored as desired in various embodiments of the invention, such as, average handle time, agent call quality scores, average hold time, average wrap-up or after-work time, transfer rate, complaint rate, customer satisfaction statistics, etc.

In order to route a call, the call routing module 132 and/or other components of the call routing system 100, may identify and/or determine the performance metrics that will be utilized to rank the call center agents 130a-n. The agents 130a-n will then be ranked in accordance with the one or more performance metrics that are utilized. In one example, a proficiency score may be determined for each agent, and the agents 130a-n may be ranked in accordance with the proficiency scores. An appropriate agent 130a may then be selected based at least in part on the rankings, and a call may be routed to the selected agent 130a if the agent is available. In this regard, a call may be processed by an available agent whose proficiency may be relatively higher than other available agents. Routing in this manner may lead to an improved customer experience and relatively improved overall call quality.

In some embodiments, prior to routing a call to an agent, the utilization of the agents 130a-n may be taken into account. The utilization may be taken into account after an agent is selected based on the rankings and/or during the selection of an agent based on the rankings. A wide variety of different utilization parameters and/or utilization thresholds may be taken into account as desired in various embodiments of the invention. Additionally, utilization parameters and/or utilization thresholds may be associated with a relative utilization of an agent with respect to other agents and/or with a target utilization of an agent. For example, an absolute ceiling of approximately eighty-five percent (85%) utilization may be established for a particular agent, such as, a top ranked agent. Continuing with the example, a relative utilization rule may be implemented to increase the ceiling for the top-ranked agent and/or other top-ranked agents if the overall utilization for a group of top-ranked agents exceeds approximately eighty percent (80%). A wide variety of different algorithms, preferences, and/or rules may be utilized as desired in various embodiments of the invention to establish or set an agent's target utilization and/or an agent's utilization relative to other agents.

As another example of utilization rules or parameters, agent idle time and/or availability time within a queue of available agents may be taken into consideration. In this regard, a call may be routed to an agent that has been available for a relatively longer period of time than another agent that may have a higher base proficiency score. One example of factoring utilization into agent selection is discussed in greater detail below with reference to FIG. 3 and 5. The utilization parameters and/or utilization thresholds may be determined in accordance with a variety of different inputs and/or methods. For example, default utilization parameters, call center defined utilization parameters, call center client defined utilization parameters, and/or customer or caller defined utilization parameters may be utilized as desired in various embodiments of the invention. Additionally, the utilization parameters may be stored in one or more suitable storage devices, such as, in database 135.

The components illustrated in FIG. 1 are only one example of components that may be included in a call routing system 100 in accordance with various embodiments of the invention. In other embodiments of the invention, more than or less than all of the components illustrated in FIG. 1 may be provided.

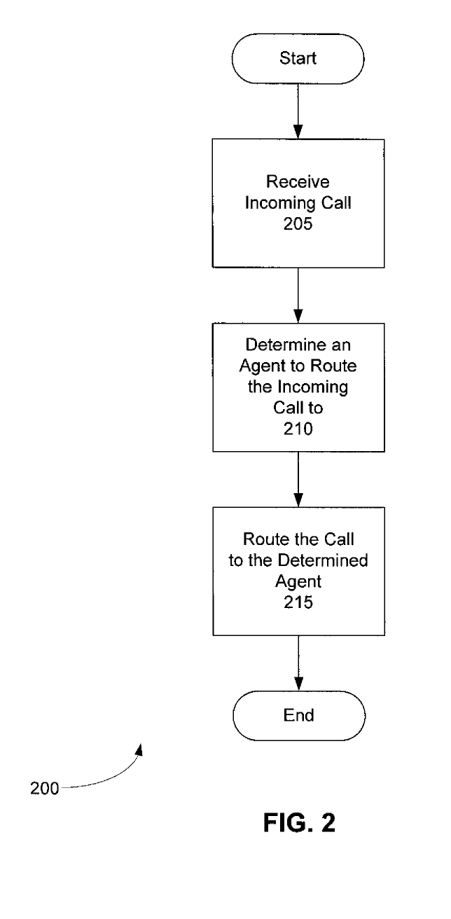

FIG. 2 is a flowchart depicting one example method 200 for processing a call received by a call routing system, such as call routing system 100, according to an illustrative embodiment of the invention. The method 200 illustrates a high level method for processing or handling a call received by the call routing system 100.

The method 200 may begin at block 205, and an incoming call may be received by the call routing system 100. The incoming call may be received via a suitable network, for example, a suitable telecommunications network. The incoming call may be held in an inbound call queue, such as queue 110, until it is routed to an appropriate call center agent, such as agent 130a.

At block 210, a determination may be made as to the most appropriate agent to route the call to. The determination may be made based at least in part on ranking or otherwise prioritizing the various call center agents in accordance with one or more performance metrics. In some embodiments, the determination may additionally be based on one or more utilization parameters and/or utilization thresholds associated with the call center agents, for example, target utilizations and/or relative utilizations associated with the call center agents. Once an appropriate agent 130a is determined at block 210, the call may be routed to the agent 130a at block 215. The method 200 may end following block 215.

The operations described and shown in the method 200 of FIG. 2 may be carried out or performed in any suitable order as desired in various embodiments of the invention. Additionally, in certain embodiments, less than or more than the operations described in FIG. 2 may be performed.

FIG. 3 is a flowchart depicting one example method 300 for routing a call based at least in part on one or more performance metrics, according to an illustrative embodiment of the invention. The method 300 may begin at block 305. At block 305, one or more metrics for agent performance, or performance metrics, may be identified and/or determined. Additionally, if more than one performance metric is utilized, corresponding weightings for the performance metrics may be identified and/or determined. The identification and/or determination of the performance metrics and the respective weightings, may be made based at least in part on call center preferences, call center client preferences, and/or caller preferences, as described in greater detail above with reference to FIG. 1. Alternatively, the identification and/or determination of the performance metrics and the respective weightings may be based on default values. A wide variety of different performance metrics may be utilized as desired in embodiments of the invention, for example, average handle time, agent call quality scores, average hold time, average wrap-up or after work time, transfer rate, etc. By way of example only, it will be assumed that average call handle time is determined to be a performance metric by which the call center agents, such as agents 130a-n, will be ranked.

Following the identification and/or determination of the one or more performance metrics and respective weightings at block 305, operations may continue at block 310. At block 310, the call center agents 130a-n may be ranked according to the one or more performance metrics. The agents 130a-n may be individually ranked or, alternatively, groups of agents may be ranked. Additionally, if groups of agents are ranked, the individual agents may be ranked within the group in certain embodiments of the invention. The agents 130a-n may be ranked in accordance with a wide variety of different techniques or methods. As one example, a proficiency score may be determined for each agent based at least in part on the determined performance metrics and historical information associated with calls that have been handled by each agent.

As an example, a performance metric, such as average handle time, may have a scale associated with it, and a certain number of points may be added to an agent's proficiency score based upon where the agent falls on the scale. Continuing with the example, historical information relating to the agent's average handle time for previously processed calls may be compared to the scale in order to determine the number of points that will be added to the agent's proficiency score. The points may then be weighted accordingly if multiple performance metrics are utilized. Once all of the performance metrics have been analyzed and weighted in this manner, a base proficiency score may be determined for the agent 130a. Base proficiency scores may be determined for each agent, and the agents may be ranked according to their base proficiency scores. Other methods and techniques for ranking agents may be utilized as desired in various embodiments of the invention.

Once the call center agents 130a-n have been ranked at block 310, operations may continue at block 315 and an available agent, such as agent 130a, may be identified based at least in part on the agent's rank according to the determined performance metrics. At block 320, which may be conducted in parallel with block 315 in certain embodiments of the invention, a determination may be made as to whether the available agent 130a satisfies one or more relative utilization thresholds and/or one or more absolute utilization thresholds.

If it is determined at block 320 that the agent 130a does not satisfy the one or more relative utilization thresholds and/or the one or more absolute utilization thresholds, then operations may continue at block 315 and another available agent may be identified based in part on the agent rankings. If, however, it is determined at block 320 that the agent 130a satisfies the one or more relative utilization thresholds and/or the one or more absolute utilization thresholds, then operations may continue at block 325 and the agent 130a may be selected as the agent to which an income call is to be routed.

A wide variety of different utilization thresholds may be utilized as desired in various embodiments of the invention. As one example, an agent's utilization and/or wait time since processing a call may be compared to a utilization threshold and/or to the utilizations or wait times of other agents. For example, if the agent's utilization is higher than a utilization threshold or if the agent's utilization is higher than that of other agent's with similar proficiency scores, then a determination may be made that a call should be routed to a different agent.

As another example, agent proficiency scores may be incremented or increased over time as agents wait for a call to process. Thus, the base proficiency score for each agent may be incremented as the agent waits for a call to process. Thus, given a sufficient waiting time, the proficiency score of an agent with a lower base efficiency score relative to another agent may be incremented such that the proficiency score associated with the agent is greater than that of the other agent. For example, if the agent with the higher base proficiency score has recently processed a call and the agent with the lower base efficiency score has been waiting to process a call, then the proficiency score associated with the waiting agent may be greater than that of the agent that recently processed a call. Thus, the agent with the lower base efficiency score may be selected to process a call based at least in part on a comparison of the proficiency scores of the various agents.

Other examples of utilization criteria, utilization thresholds, and/or utilization parameters will be apparent to those skilled in the art. Any number of different utilization parameters, criteria, and/or thresholds may be utilized as desired in various embodiments of the invention.

An inbound call may be received at a variety of different points in the method 300. For example, an inbound call may be received prior to the determination of one or more performance metrics at block 305. As another example, an inbound call may be received following the ranking of the agents in accordance with the one or more performance metrics at block 310. As yet another example, a call may be received between blocks 320 and blocks 325. An inbound call may be received at other points in various other embodiments of the invention.

An incoming call may be routed to the agent that is selected in block 325. The call may be processed by the agent. With continued reference to FIG. 3, the processing of the call may end at block 330. For example, the processing of the call may end after the caller hangs up and the agent completes any after-call work, such as, filling out service tickets, etc.

Once the call has been processed, information associated with the processed call may be stored. A wide variety of information associated with the call may be stored as desired in various embodiments of the invention, for example, the handling time for the call, an indication of whether the call was transferred, information associated with customer satisfaction, etc. Customer satisfaction information may be determined, for example, from answers received from a customer survey that is completed following the call. As another example, customer satisfaction information may be derived from a customer voice pitch and/or tone that is determined during the call.

In block 335, which may be optional in certain embodiments of the invention, the agents 130a-n may be re-ranked following the processing of the call. In this regard, the agent rankings may be adjusted dynamically following the processing of a call. For example, if agent proficiency scores are utilized to rank the agents, then the base proficiency score for the agent that processed the call may be re-calculated following the processing of the call. The agent's rank relative to the other agents may then be re-calculated following any adjustments that are made to the agent's base proficiency score.

Although block 335 describes a method in which agent rankings may be re-calculated following each processed call, in certain embodiments of the invention, agent rankings may be re-calculated based on other criteria. For example, agent rankings may be re-calculated following the processing of a pre-determined number of calls, such as, 20 calls, 100 calls, etc. As another example, agent rankings may be re-calculated at predetermined time intervals, such as, once a day, once a week, once a month, etc. As yet another example, agent rankings may be re-calculated at specific predetermined points in time, such as, every hour, etc.

The method 300 may end following block 335.

The operations described and shown in the method 300 of FIG. 3 may be carried out or performed in any suitable order as desired in various embodiments of the invention. Additionally, in certain embodiments, less than or more than the operations described in FIG. 3 may be performed. Furthermore, as discussed above, two or more of the operations may be carried out in parallel with one another.

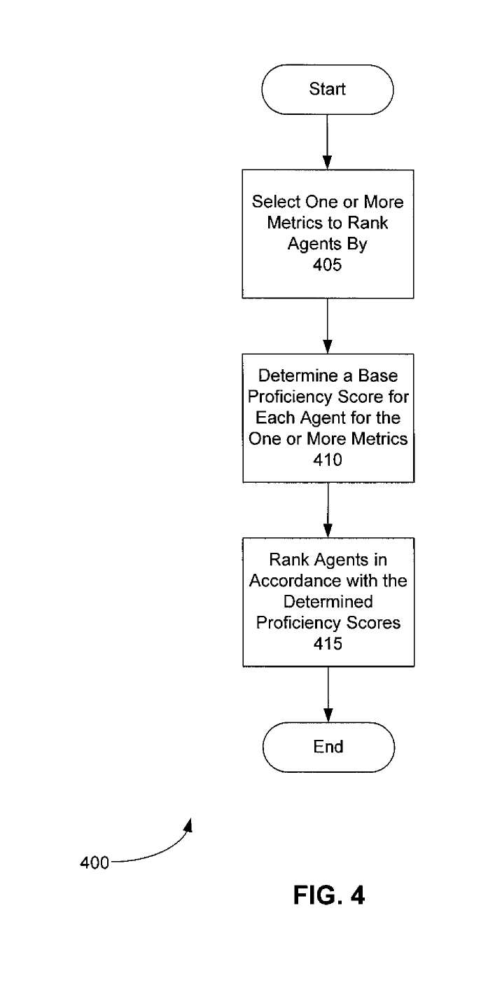

FIG. 4 is a flowchart depicting one example method 400 for ranking call center agents, such as agents 130a-n, according to an illustrative embodiment of the invention. The method 400 may begin at block 405. At block 405, one or more metrics for ranking the agents 130a-n may be selected, identified, or otherwise determined. The one or more metrics may be identified and/or determined from a wide variety of different data, for example, default metrics or predetermined preferences. Additionally, the one or more metrics may be any performance metrics as desired in various embodiments of the invention.

Following the selection, identification, or determination of the one or more metrics at block 405, operations may continue at block 410. At block 410, a proficiency score may be determined for an agent or for a group of agents based at least in part on the one or more metrics. Proficiency scores may be determined individually for each agent and/or for a group of agents. The proficiency score may be a base proficiency score for an individual agent or for a group of agents. As explained in greater detail above, a proficiency score may be determined based at least in part on a comparison of historical call processing information for the agent or group of agents to scoring information associated with the one or more metrics. For example, a metric may define a scale or range of values and a proficiency score may be determined by comparing at least a portion of the historical call processing information to the scale or range. A proficiency score may then be determined based at least in part on the comparison. As an example utilizing average handle time as a performance metric, a scale or range may be provided that associates increasing point values with decreasing average handle time. An average handle time may be determined for an agent from historical data and it may be matched to a corresponding value in the scale or range. The point value associated with the average handle time may then be utilized in a determination of the agent's proficiency score.

Once a proficiency score is determined for each agent or for each group of agents at block 410, operations may continue at block 415, and the agents may be ranked in accordance with their proficiency scores. In this regard, incoming calls may be routed or assigned to agents that are capable of processing the calls in a timely and/or satisfactory manner. Routing calls in this manner may lead to improved customer satisfaction.

The method 400 may end following block 415.

The operations described and shown in the method 400 of FIG. 4 may be carried out or performed in any suitable order as desired in various embodiments of the invention. Additionally, in certain embodiments, less than or more than the operations described in FIG. 4 may be performed. Furthermore, as discussed above, two or more of the operations may be carried out in parallel with one another.

FIG. 5 is a flowchart depicting one example method 500 for processing a call received by a call routing center, such as call routing center 100, according to an illustrative embodiment of the invention. The method 500 relates to various embodiments of the invention in which call routing is based at least in part on base proficiency scores that are modified over time to take an agent's utilization into account. The method 500 is provided by way of example only. Other embodiments of the invention may utilize different methods or techniques to rank agents and/or to take utilization parameters and/or utilization thresholds into account.

The method 500 may begin at block 505. At block 505, base proficiency scores may be determined for each agent and/or for groups of agents based at least in part on one or more performance metrics and historical data associated with the agents and/or groups of agents. In one embodiment, the base proficiency scores may be determined based at least in part on a comparison of score data associated with the one or more performance metrics to at least a portion of the historical data. Additionally, in various embodiments of the invention, weighting factors may be applied to each of the performance metrics. In this regard, the base proficiency scores that are determined from the one or more performance metrics may be weighted accordingly.

With continued reference to block 505, the agents or groups of agents may be ranked in accordance with the determined base proficiency scores. The rankings of the agents or groups of agents may facilitate the selection of an appropriate agent to which a received call is routed. For example, a received call may be routed to the agent with the highest proficiency score.

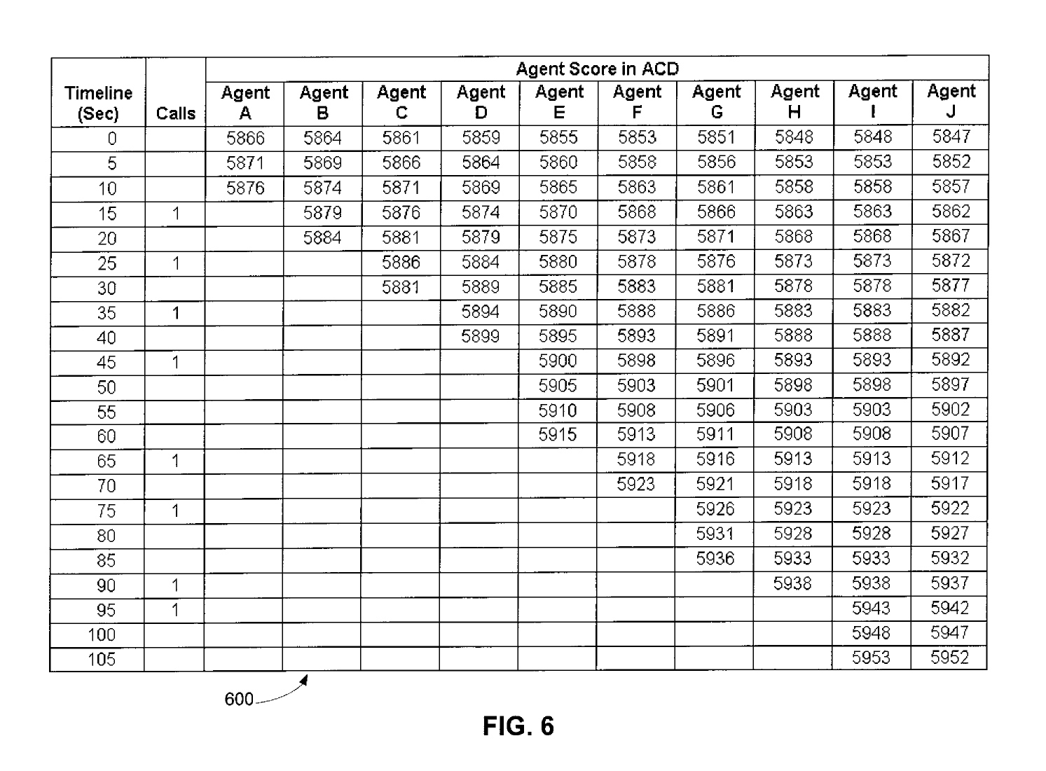

Once the base proficiency scores have been determined and the agents and/or groups of agents have been ranked at block 505, operations may continue at block 510. At block 510, the base proficiency score of each agent and/or groups of agents may be modified as time passes without an incoming call being routed to the agent or group of agents. For example, the base proficiency score of an agent may be incremented by a predetermined amount at predetermined time intervals if a call is not routed to the agent for processing. An example of incrementing proficiency scores is described below with reference to FIG. 6, in which a proficiency score is incremented by one for every second that an agent waits for a call. Although the proficiency scores are illustrated in FIG. 6 as being incremented by one for every second that an agent waits for a call, other modification values and/or time intervals may be utilized as desired in various embodiments of the invention. In this regard, the utilization of the various agents may be taken into account.

With continued reference to FIG. 5, once a call is received by a call routing system 100, the call may be routed to an agent at block 515. An agent to which the call is routed may be selected based at least in part on the proficiency scores of the various agents or groups of agents, which have been modified as time passes. For example, if the agent proficiency scores are incremented as time passes while the agent is idle, then the agent with the highest proficiency score may be selected, and the call may be routed to that agent. In this regard, both the performance and utilization of agents may be taken into account when routing calls.

Once the call is routed to an agent at block 515, the agent may process the call at block 520. Once the call has been processed at block 520, operations may continue at block 525 and parameters and/or data associated with the processed call may be determined. A wide variety of different parameters and or data associated with the call may be determined as desired in various embodiments of the invention, for example, call handle time, customer satisfaction parameters, etc. Additionally, this information may be stored in certain embodiments as historical data associated with the agent or group of agents responsible for processing the call. If the information is stored as historical information, the information may supplement previously stored historical information.

Once parameters and/or data associated with the processed call have been determined at block 525, operations may continue at block 530. At block 530, the base proficiency score of the agent and/or group of agents may be re-calculated taken the parameters and/or data of the processed call into account. The re-calculation of a base proficiency score may be made at a wide variety of different point in time as desired in various embodiments of the invention, for example, in real time or near real time following the processing of a call or in a batch process that is completed at predetermined time intervals.

Following the re-calculation of an agent and/or group of agents' base proficiency score at block 530, operations may continue at block 535. At block 535, a determination may be made as to whether the base proficiency score has changed relative to other agents and/or groups of agents. If it is determined at block 535 that the base proficiency score has not changed relative to other agents and/or groups of agents, then the method 500 may end. If, however, it is determined at block 535 that the base proficiency score has changed relative to other agents and/or groups of agents, then operations may continue at block 540, and the agents and/or groups of agents may be re-ranked taken the new base proficiency score into account. The method 500 may then end following block 540.

The operations described and shown in the method 500 of FIG. 5 may be carried out or performed in any suitable order as desired in various embodiments of the invention. Additionally, in certain embodiments, less than or more than the operations described in FIG. 5 may be performed. Furthermore, as discussed above, two or more of the operations may be carried out in parallel with one another.

FIG. 6 is a chart 600 illustrating one example of modifying agent scores over time in a call routing system, according to an illustrative embodiment of the invention. The chart 600 illustrates an embodiment of the invention in which base proficiency scores for individual call center agents, such as agents 130a-n, are incremented over time if the agent remains idle. In other words, the proficiency score of an agent is periodically increased as long as the agent is not processing a call.

With reference to FIG. 6, a plurality of agents, such as agents 130a-n, are ranked in accordance with their proficiency scores. At a starting points in time, the available agents are ranked in accordance with their base proficiency scores. As shown, a first agent has a base proficiency score of 5866, a second agent has a base proficiency score of 5864, and so on. The proficiency scores are incremented by one point for every second than an agent remains idle. Thus, after five seconds, each agent's score has been increased by five because no calls have been received.

With continued reference to FIG. 6, a call is received after approximately 15 seconds and the call is routed to the first available agent because the first agent has the highest modified proficiency score. Thus, the first agent processes the call. After the first agent processes the call, the first agent's proficiency score will return to the base proficiency score. Additionally, in certain embodiments, the first agent's base proficiency score may be re-calculated based on data associated with the call that was processed.

Over time, the proficiency scores of idle agents are incremented. As calls are received, the call are routed to the agent with the highest adjusted proficiency score. In this regard, received calls may be routed based at least in part on the proficiency of the agents and on the utilization of the agents.

The invention is described with reference to block diagrams of systems, methods, apparatuses and computer program products according to an embodiment of the invention. It will be understood that each block of the block diagrams, and combinations of blocks in the block diagrams, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functionality of each block of the block diagrams, or combinations of blocks in the block diagrams discussed in detail in the descriptions below.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational elements to be performed on the computer or other programmable apparatus to produce a computer implemented process such that the instructions that execute on the computer or other programmable apparatus provide elements for implementing the functions specified in the block or blocks.

Accordingly, blocks of the block diagrams support combinations of means for performing the specified functions, combinations of elements for performing the specified functions and program instruction means for performing the specified functions. It will also be understood that each block of the block diagrams, and combinations of blocks in the block diagrams, can be implemented by special purpose hardware-based computer systems that perform the specified functions or elements, or combinations of special purpose hardware and computer instructions.

Embodiments of the invention may be implemented through an application program running on an operating system of a computer. The embodiments also may be practiced with other computer system configurations, including hand-held devices, multiprocessor systems, microprocessor based or programmable consumer electronics, mini-computers, mainframe computers, etc.

Application programs that are components of embodiments of the invention may include routines, programs, components, data structures, etc. that implement certain abstract data types, perform certain tasks, actions, or tasks. In a distributed computing environment, the application program (in whole or in part) may be located in local memory, or in other storage. In addition, or in the alternative, the application program (in whole or in part) may be located in remote memory or in storage to allow for the practice of the inventions where tasks are performed by remote processing devices linked through a communications network.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A computer-implemented method for routing calls received at a call center, the method comprising:
identifying one or more performance metrics for ranking call center agents;
ranking a plurality of call center agents based at least in part on the one or more performance metrics;
receiving a call;
determining, based at least in part on the rankings and respective utilizations of the plurality of call center agents, one of the plurality of call center agents to route the received call to; and
routing the received call to the one of the plurality of call center agents.

2. The method of claim 1, wherein the one or more performance metrics comprise a plurality of performance metrics, and further comprising:
identifying respective weighting factors for each of the plurality of performance metrics, and
weighting the plurality of performance metrics in accordance with the weighting factors,
wherein ranking a plurality of call center agents based at least in part on the one or more performance metrics comprises ranking a plurality of call center agents based at least in part on the weighted plurality of performance metrics.

3. The method of claim 1, wherein ranking the plurality of call center agents comprises individually ranking the plurality of call center agents.

4. The method of claim 1, wherein the one or more performance metrics comprise at least one of an average call handling time, a call quality score, an average hold time, a transfer rate, or a complaint rate.

5. The method of claim 1, wherein ranking the plurality of call center agents comprises:
determining a respective proficiency score for each of the plurality of call center agents; and
ranking the plurality of call center agents based at least in part on the determined proficiency scores.

6. The method of claim 5, wherein determining the respective proficiency score for each of the plurality of call center agents comprises determining the respective proficiency score for each of the plurality of call center agents based at least in part on respective historical data associated with calls processed by each respective call center agent.

7. The method of claim 5, further comprising:
modifying the proficiency score of each of the plurality of call center agents based at least in part on a respective period of time that each of the plurality of call center agents is idle,
wherein determining one of the plurality of call center agents to route the received call to comprises determining one of the plurality of call center agents to route the received call to based at least in part on the modified proficiency scores.

8. The method of claim 1, further comprising:
processing the received call by the one of the plurality of call center agents;
identifying parameters associated with the processed call; and
re-ranking the plurality of call center agents based at least in part on the parameters associated with the processed call.

9. The method of claim 1, wherein each of the respective utilizations of the plurality of call center agents comprises at least one of an absolute utilization threshold or a relative utilization threshold.

10. A system for routing calls received at a call center, the system comprising:
at least one inbound call queue operable to receive a call;
at least one memory operable to store performance metrics for ranking call center agents; and
at least one processor operable to (i) access the at least one memory to obtain one or more performance metrics, (ii) rank a plurality of call center agents based at least in part on the one or more performance metrics, (iii) determine, based at least in part on the rankings, one of the plurality of call center agents to route the received call to, and (iv) control the routing of the call from the at least one inbound call queue to the one of the plurality of call center agents.

11. The system of claim 10, wherein the one or more accessed performance metrics comprise a plurality of performance metrics, and
wherein the processor is further operable to (i) determine respective weighting factors for each of the plurality of performance metrics, (ii) weight the plurality of performance metrics in accordance with the weighting factors, and (iii) rank the plurality of call center agents based at least in part on the weighted plurality of performance metrics.

12. The system of claim 10, wherein the at least one processor is operable to rank the plurality of call center agents by individually ranking the plurality of call center agents.

13. The system of claim 10, wherein the one or more performance metrics comprise at least one of an average call handling time, a call quality score, an average hold time, a transfer rate, or a complaint rate.

14. The system of claim 10, wherein the at least one processor is operable to rank the plurality of call center agents by determining a respective proficiency score for each of the plurality of call center agents and ranking the plurality of call center agents based at least in part on the determined proficiency scores.

15. The system of claim 14, wherein the at least one processor is operable to determine a respective proficiency score for each of the plurality of call center agents based at least in part on respective historical data associated with calls processed by each agent.

16. The system of claim 14, wherein the at least one processor is further operable to (i) modify the proficiency score of each of the plurality of call center agents based at least in part on a respective period of time that each of the plurality of call center agents is idle, and (ii) to determine one of the plurality of call center agents to route the received call to based at least in part on the modified proficiency scores.

17. The system of claim 10, wherein the one of the plurality of call center agents processes the received call, and
wherein the at least one processor is further operable to determine parameters associated with the processed call and to re-rank the plurality of call center agents based at least in part on the parameters associated with the processed call.

18. The system of claim 10, wherein the processor is further operable to determine one of the plurality of call center agents to route the received call to based at least in part on respective utilizations of the plurality of agents,
wherein each of the respective utilizations of the plurality of call center agents comprises at least one of an absolute utilization threshold or a relative utilization threshold.

19. A computer-implemented method for routing calls at a call center, the method comprising:
identifying one or more performance metrics for ranking call center agents;
determining respective proficiency scores for a plurality of call center agents based at least in part on the one or more performance metrics and on respective historical data associated with the plurality of call center agents;
ranking the plurality of call center agents based at least in part on the determined proficiency scores; and
selecting one of the plurality of call center agents as an agent to which a call is to be routed based at least in part on the rankings.

20. The method of claim 19, further comprising:
modifying the respective proficiency scores for each of the plurality of call center agents based at least in part on a corresponding idle time for each of the plurality of call center agents, and
wherein selecting one of the plurality of call center agents comprises selecting at least one of the plurality of call center agents based at least in part on the modified proficiency scores.
